(19) United States
(12) Patent Application Publication
(10) Pub. No.: US 2014/0332426 A1
(43) Pub. Date: Nov. 13, 2014

(54) CHRONOLOGICAL DOCUMENT ORGANIZER BOX

(71) Applicant: Jacqueline I David, La Canada, CA (US)

(72) Inventor: Jacqueline I David, La Canada, CA (US)

(21) Appl. No.: 13/890,525

(22) Filed: May 9, 2013

(51) Int. Cl. B42F 17/12

(52) U.S. Cl. CPC B42F 17/12
USPC 206/425

(57) ABSTRACT

A chronological document organizer box is disclosed. According to one preferred embodiment, an apparatus for organizing documents comprises a first box and a plurality of second boxes sized such that a finite number of said second boxes fit within the first box, wherein each of the second boxes represents an accounting period. A plurality of separators defines two or more slots within each second box that are capable of storage of account-related documents, wherein each slot represents an account.

Disclosed and described is a chronological document organizer box. Specifically, a chronological organizer system and method is for organizing documents and things by months of the year.

### BACKGROUND OF THE INVENTION

Prior art systems have tried and failed to provide for easy organization of documents, specifically, accounting documents over months and years, or the like.

For example, U.S. Pat. No. 5,547,226 discloses a filing system for storing, organizing, and handling household documents and data, which includes a file container in which a series of file folders are supported. Each file folder is provided with a label for a general topic and a related color for ease of identification. In general, red file folders are used for the distribution of information, mail processing, bills to be paid, and paperwork to be filed. Green file folders are used for the documentation of money received and expensed paid out. Orange file folders store information related to auto expenses and insurance, mortgage and loans, and taxes and personal finances. Blue file folders are designated for storage of information relating to legal, medical and dental, and general family matters. Information regarding general household and community matters is stored in yellow file folders. Within each file folder are a plurality of file folders, each labelled with subheadings for topics that are specific subjects relating to the general topic of the larger file folder and provided with the same color as the file folder in which it resides. In addition, selected file folders are provided with one or more icons in addition to topic labels. Each icon represents a cross-reference to another file folder. One icon indicates that further information is contained in another file folder. Another icon indicates that information within the file folder is relevant to filing tax returns. In addition, an icon may indicate that the file folder contains copies of documents, which are stored elsewhere; e.g., safe, fireproof box, or sale deposit box. A further icon may indicate that the file folder contains information forms to be completed by the user, so that necessary information is elicited, organized, and stored for easy retrieval.

U.S. Pat. No. 2,229,426 discloses containers useful for packing, shipping and displaying merchandise.

Other systems available in the market provide a monthly file folder organizer that provides a box with folders divided into the twelve months of the year for organizing documents.

None of these or other prior art systems provide suitable, stackable systems that allow for easy chronological organization of documents categorized by month, and account or type, as shown and described in the instant invention as claimed. Thus, such a system for solving the aforementioned problems is desired.

### SUMMARY OF THE INVENTION

In order to solve the problems and shortcomings of the prior art, a chronological document organizer box is disclosed. According to one preferred embodiment, an apparatus for organizing documents comprises: a first box; a plurality of second boxes sized such that a finite number of said second boxes fit within the first box, wherein each of the second boxes represents an accounting period; and a plurality of separators defining two or more slots within each second box capable of storage of account-related documents, wherein each slot represents an account.

According to yet another preferred embodiment, an apparatus for organizing documents comprises: a banker's box having month labels on a side; a plurality of monthly boxes sized such that twelve of said second boxes fit within the banker's box; and a plurality of separators defining two or more slots within each monthly box capable of storage of account-related documents, wherein each slot represents an account.

### BRIEF DESCRIPTION OF THE DRAWINGS

FIG. 1 is a front, right, top perspective view of a chronological document organizer box according to one embodiment;

FIG. 2 is a front, right, top perspective view of a monthly box removed from the banker's box according to the embodiment of FIG. 1;

FIG. 3 is a top elevational view of a monthly box according to FIG. 2;

FIG. 4 is a top elevational view of the banker's box;

FIG. 5 is a cross sectional side view of the banker's box of FIG. 4 shown with the first six months of monthly boxes for the year inserted therein; and

FIG. 6 is a bottom perspective view of a transparent banker's box shown with the first six months of monthly boxes for the year inserted therein, and two monthly boxes ready to be inserted into the banker's box according to the embodiment of FIG. 5.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

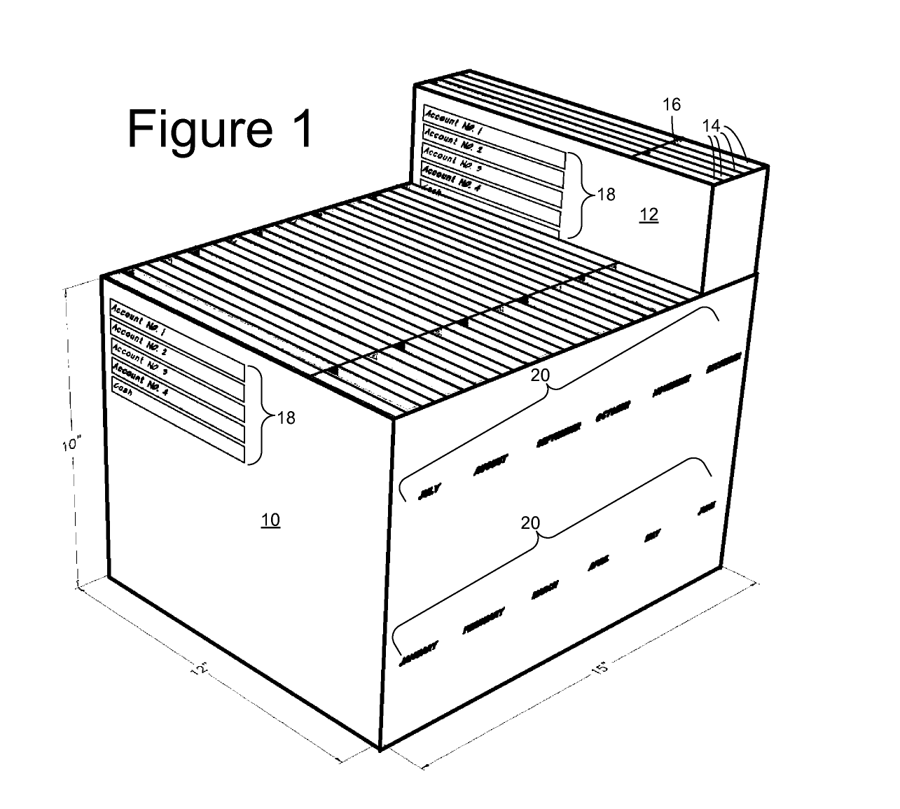

The chronological document organizer box in accordance with preferred embodiments of the present invention is illustrated in FIGS. 1-6 wherein like reference numerals are used throughout to designate like elements.

With reference to FIG. 1, a front, right, top perspective view of a chronological document organizer box 10 according to one embodiment is shown. In one embodiment, a set of twelve smaller or monthly boxes 12 are able to fit into a larger box 10, wherein each monthly box 12 represents a month in a year. In one embodiment, each of the monthly boxes 12 may be further divided into a number of slots 14, each slot representing, by way of example, and not by way of limitation, one or more accounts or different categories of documents for the particular month that the monthly box 12 represents. Each of the slots 14 may be further divided by a divider 16. The divider 16 may, by way of example, and not by way of limitation, divide each slot 14 so that smaller receipts may be put into a smaller portion of the slot 14, and larger receipts or documents may be placed into a larger portion of the slot 14.

In one embodiment, on the side of each monthly box 12 may be changeable tags 18 to indicate which slots 14 are for which document types or accounts. The tags 18 may comprise, by way of example and not by way of limitation, clear rewritable plastic that can be written on or printed on using erasable, permanent, or semi-permanent ink. In another embodiment, the tags 18 may comprise removable or magnetic labels that may be fit into slots or slid into extruded plastic holders. Further, the tags may be color coded with the slots 14, each slot 14 having the same coloring as the relevant one of the tags 18 for which the slot 14 is labelled.

In one embodiment, by way of example and not by way of limitation, the larger box 10 may comprise and have the same dimensions as a so-called standard banker's box 10. In FIG. 1, as just one example, and not by way of limitation, the dimensions of the banker's box 10 may be ten inches in height and twelve inches in width. However, these example dimensions are not to be viewed in the limiting sense, and only as an exemplary embodiment. Using banker's box dimensions may, for example, may allow for ease of storage in such a standard format. For convenience, the terms banker's box 10 and larger box 10 may be used interchangeably herein.

In one embodiment, the monthly boxes 12 may fit into the banker's box 10 in a stacked 6×6 configuration. Month labels 20 on the side of the banker's box 10 may indicate the month for the position of each monthly box 12 as it is stored in the banker's box 10. As with the account tags 18, the month labels 20 may be color-coded to the monthly boxes 12. However, in some embodiments, this is not necessary or needed.

In one embodiment, each of the month labels 20 may comprise a transparent portion such that when the corresponding monthly box 12 is inserted, the corresponding month label 20 changes color according to the color coding of the monthly box 12. For example, if the monthly box 12 is blue on the side, when inserted into banker's box 10, the transparency of the monthly label 20 causes it to appear as blue when the January monthly box 12 is inserted into the banker's box 10.

However, in other embodiments, the monthly boxes 12 may not be color-coded and may be black and white or a single color. In one embodiment, the month labels 20 may still be transparent so as to determine whether each monthly box 12 is inserted, even if not in different colors.

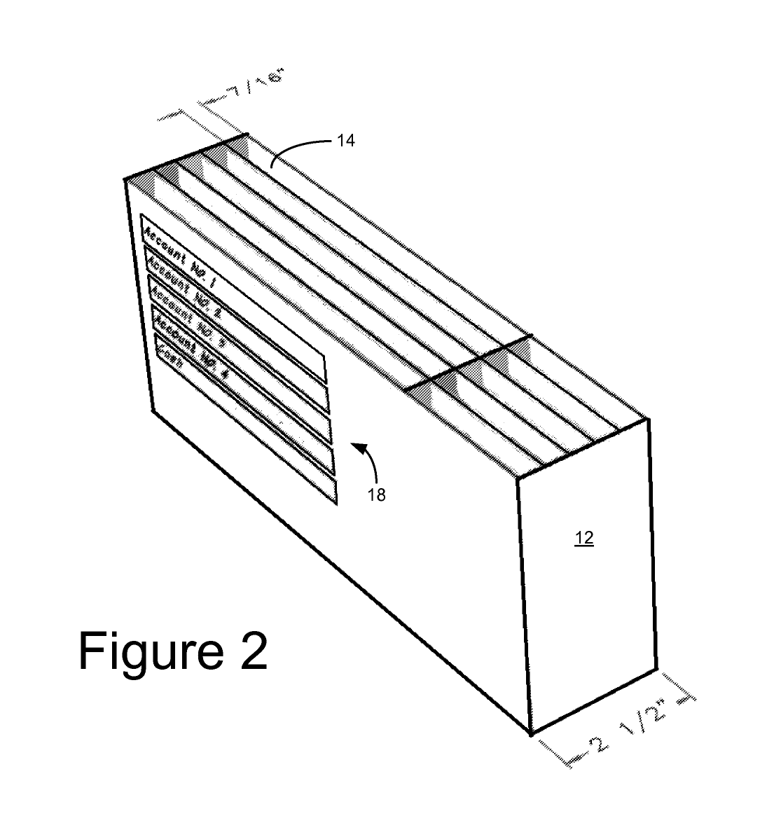

With reference to FIG. 2, a front, right, top perspective view of a monthly box 12 removed from the banker's box 10 is shown according to the embodiment of FIG. 1. Again, as an example, the banker's box 10 of FIG. 1 many have banker's box dimensions, and so the monthly box 12 of FIG. 2 may be sized such that six monthly boxes 12 may fit into the banker's box 10 in FIG. 1. For example, the monthly box 12 may be two and one-half inches wide, and have a height such that it may fit one above the other in the banker's box 10 when inserted. Each slot 14 may have equal 7/16 inch widths providing for five slots 14 across within the monthly box 12. However, in other embodiments, the slots 14 may have smaller or larger widths to provide for more or less accounts per monthly box 12.

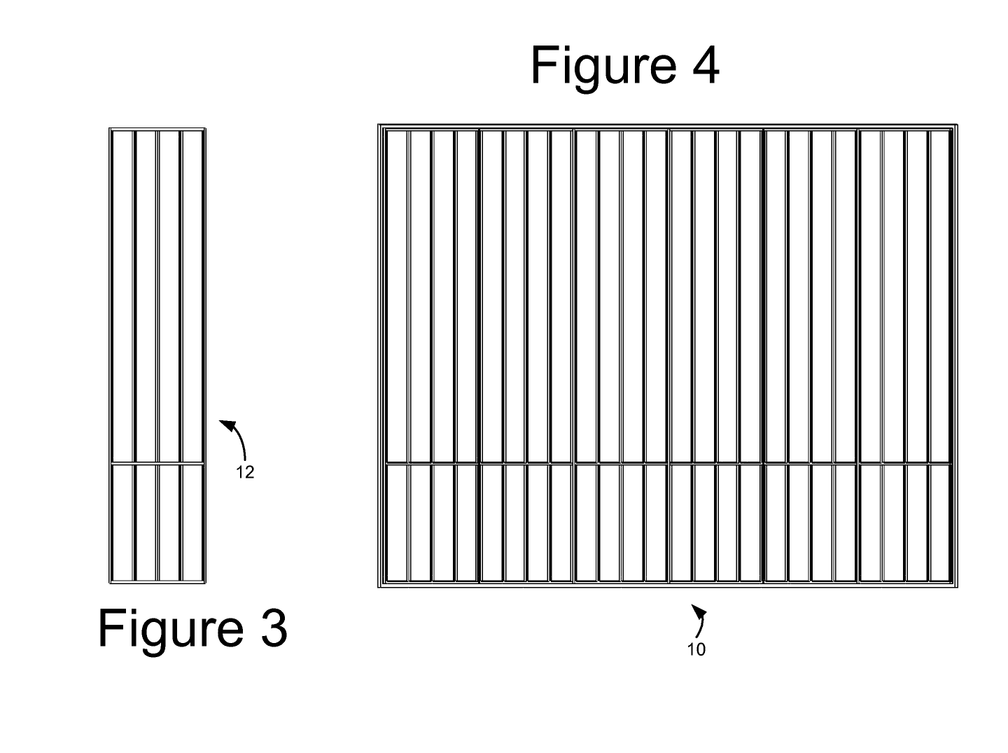

With reference to FIGS. 3, a top elevational view of a monthly box 12 is shown. With further reference to FIG. 4, a top elevational view of the banker's box 10 is shown. In use, by way of example, and not by way of limitation, throughout the year, during each relative month, a user may use the monthly box 12 for that month, and store collected tax receipts in the monthly box 12. At the end of the month, the user may simply store the monthly box 12 for that month in the appropriate position, and use the monthly box 12 for the next month to store receipts. The month labels on the bankers box 10 organizes the monthly boxes in such a manner as to allow sequential stacking of the monthly boxes 12 for each month in an order from one side to another for the first 6 months, and then from one side to another for the latter 6 months of the year. This allows for easier stacking of the monthly boxes 12, not requiring the user to remove previous months' monthly boxes 12 to complete stacking throughout the year. At the end of the year, the user's receipts are readily organized for easier bookkeeping.

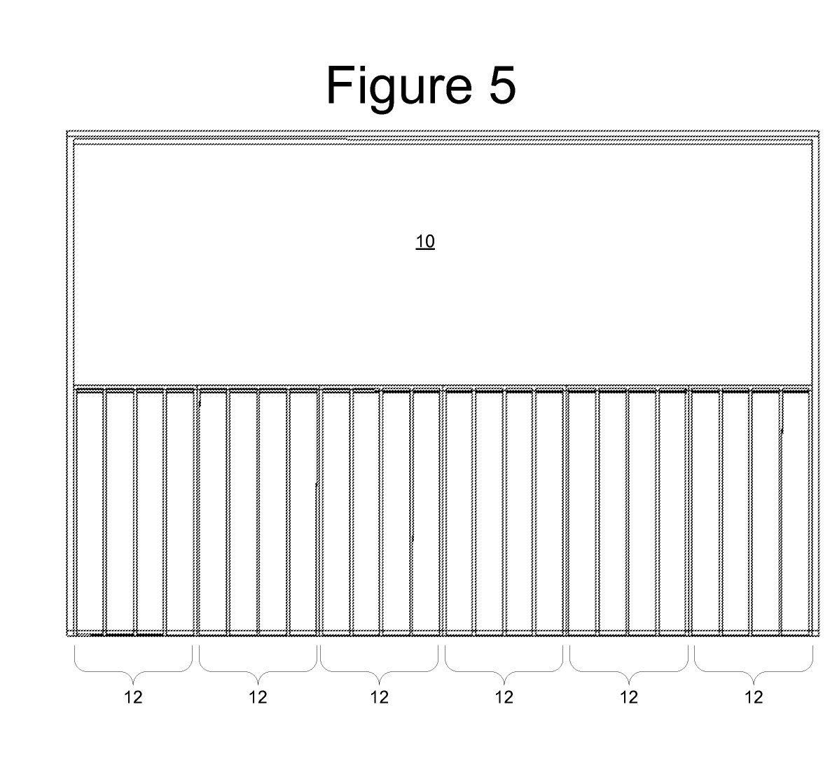

With reference to FIG. 5, a cross sectional side view of the banker's box 10 of FIG. 4 is shown with the first six months of monthly boxes 12 for the year inserted therein. As shown in FIG. 5, when the first six months of monthly boxes 12 are inserted into the banker's box 10, space is left above them for insertion of the last six months of monthly boxes 12.

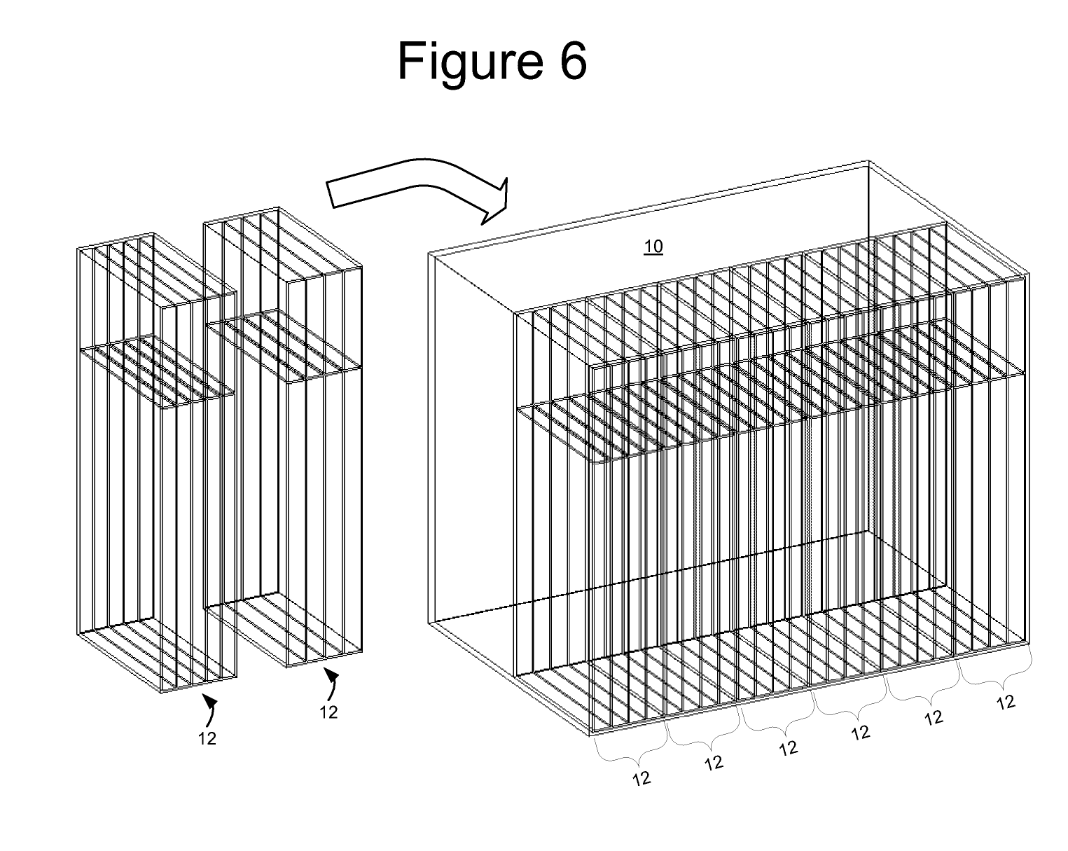

With reference to FIG. 6, a bottom perspective view of a transparent banker's box 10 is shown with the first six months of monthly boxes 12 for the year inserted therein, and two monthly boxes 12 ready to be inserted into the banker's box 10. As shown in FIG. 6, when the first six months of monthly boxes 12 are inserted into the banker's box 10, space is left above them for insertion of the last six months of monthly boxes 12.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. An apparatus for organizing documents comprising:
a first box;
a plurality of second boxes sized such that a finite number of said second boxes fit within the first box, wherein each of the second boxes represents an accounting period; and
a plurality of separators defining two or more slots within each second box capable of storage of account-related documents, wherein each slot represents an account.

2. The apparatus of claim 1, wherein the accounting period represents a month in a calendar year.

3. The apparatus of claim 2, wherein the plurality of second boxes comprises twelve boxes.

4. The apparatus of claim 3, wherein the plurality of second boxes fit within the first box in a configuration of six of the second boxes in a bottom portion of the first box and six of the second boxes in a top portion of the first box.

5. The apparatus of claim 4, further comprising month labels on a side of the first box, each month label indicating the month represented by one of said second boxes adjacent to the label.

6. The apparatus of claim 5, each second box further comprising two or more account tags on a side of the second box indicating the account represented by each slot.

7. The apparatus of claim 5, wherein each second box is color-coded by month.

8. The apparatus of claim 7, wherein each month label comprises a transparent label, such that the month label appears as the same color as the second box when the second box is inserted into the first box.

9. An apparatus for organizing documents comprising:
a banker's box having month labels on a side;
a plurality of monthly boxes sized such that twelve of said second boxes fit within the banker's box; and
a plurality of separators defining two or more slots within each monthly box capable of storage of account-related documents, wherein each slot represents an account.

10. The apparatus of claim 9, wherein the plurality of monthly boxes fit within the banker's box in a configuration of six of the monthly boxes in a bottom portion of the banker's box and six of the monthly boxes in a top portion of the banker's box.

11. The apparatus of claim 10, further comprising month labels on a side of the banker's box, each month label indicating the month represented by one of said monthly boxes adjacent to the label.

12. The apparatus of claim 11, wherein each monthly box is color-coded by month.

13. The apparatus of claim 12, wherein each month label comprises a transparent label, such that the month label appears as the same color as the monthly box when the monthly box is inserted into the banker's box.

14. The apparatus of claim 9, each banker's box further comprising two or more account tags on a side of the banker's box indicating the account represented by each slot.
